(19) United States
(12) Patent Application Publication
(10) Pub. No.: US 2012/0274296 A1
(43) Pub. Date: Nov. 1, 2012

(54) SWITCHED-MODE POWER SUPPLY

(75) Inventors: Yoshitaka HIGUCHI, Tokyo (JP); Heisuke Nakashima, Tokyo (JP); Yuji Yamanaka, Tokyo (JP)

(73) Assignee: MITSUMI ELECTRIC CO., LTD, Tokyo (JP)

(21) Appl. No.: 13/458,107

(22) Filed: Apr. 27, 2012

(30) Foreign Application Priority Data
Apr. 28, 2011 (JP) 2011-100916

(51) Int. Cl. G05F 1/46

(52) U.S. Cl. 323/282

(57) ABSTRACT

Provided is a switched-mode power supply. The power supply includes: a DC voltage input terminal; a driver switching element connected to the input terminal; an inductor connected to the driver switching element; an output terminal connected to the inductor and outputting output voltage different from the input voltage; and an integrated circuit outputting control pulses used for on-off control of the driver switching element. The integrated circuit has: a ripple injection circuit adding a ripple component to a feedback voltage of the output voltage; a voltage comparator comparing the summed voltage with a predetermined voltage; and a control pulse generator generating the control pulse based on an output of the voltage comparator. The ripple injection circuit has an integrator outputting an integral of the voltage at the node between the driver switching element and the inductor, and a series RC circuit connected to the output end of the integrator.

### CROSS-REFERENCE TO RELATED APPLICATION

The present U.S. patent application claims a priority under the Paris Convention of Japanese patent application No. 2011-100916 filed on Apr. 28, 2011, which shall be a basis of correction of an incorrect translation, and is incorporated by reference herein.

### BACKGROUND OF THE INVENTION

1. Field of the Invention

The present invention relates to a DC-DC converter which transforms DC voltage based on the switching regulator system, and in particular to a switched-mode power supply having a ripple injection function.

2. Description of the Related Art

DC-DC converter based on the switching regulator system has been known as a circuit which transforms DC input voltage into a different level of DC voltage. This sort of DC-DC converter has a driver switching element, a rectifier element, and a control circuit. The driver switching element applies DC voltage, received from a DC power supply such as a battery, to an inductor (coil) to thereby feed current thereto and accumulate the energy therein. The rectifier element controls current which flows through the coil, in the period of discharging energy while the driver switching element is turned off. The control circuit performs on-off control of the driver switching element.

Conventionally known control methods for the DC-DC converter based on the switching regulator system include voltage control system, current control system, and ripple control system. The voltage control system modulates pulse width or frequency of drive pulse for the switching element based on feedback of the output voltage. The current control system is an improved version of the voltage control system. The voltage control system and the current control system, however, suffer from slow response to abrupt changes in load.

On the other hand, the ripple control system performs on-off control of the switching element, upon detection that the output voltage being monitored falls below (or exceeds) a preliminarily-set threshold value. The ripple control system is intrinsically free from delay ascribable to frequency characteristics of an error amplifier, and may therefore achieve faster response to changes in load as compared with the voltage control system and the current control system.

The DC-DC converter based on the ripple control system generally makes use of a triangular wave (ripples) which appears in the output voltage ascribable to ESR (equivalent series resistance), a resistance component owned by a smoothing capacitor connected to an output terminal. The output voltage is kept constant by monitoring the output voltage using a comparator, and by repetitively turning the switching element on over a predetermined period upon every detection that the output voltage falls below a predetermined value.

Conventionally, electrolytic capacitors, having a relatively large ESR, have been used as the capacitor for smoothing the output voltage. The ripple control has, therefore, never been interrupted due to shortage of the ripples. However, recent growing need in the market of digital home electric appliances is directed to ceramic capacitors having smaller ESR, aiming at reducing the ripples per se, the external dimensions, and the cost. Capacitors having small ESR, however, scarcely produce the ripple component, and disable the ripple control. One known proposal is directed to a switched-mode power supply configured to inject the ripple component into feedback voltage of the output voltage (see Japanese Examined Patent No. 4610588).

### SUMMARY OF THE INVENTION

A ripple injection circuit in the switched-mode power supply of the prior art is configured, as illustrated in FIG. 7, by a coil L1, a RC circuit, a voltage divider circuit, and a feed-forward capacitor Cff. The RC circuit is connected between the coil L1 and an input terminal of a comparator 23, and is configured by a capacitor Cinj and a resistor Rinj. The voltage divider circuit is configured by resistors R_{fb1} and R_{fb2} connected in series, and divides the output voltage Vₒᵤₜ, and feeds the divided voltage to the input terminal of the comparator 23. The feed-forward capacitor Cff is connected between the node of the resistors R_{fb1} and R_{fb2}, and the output terminal Vₒᵤₜ.

The ripple injection circuit needs a terminal to which the feed-forward capacitor Cff is connected, besides the terminal to which the output voltage Vₒᵤₜ is applied. The number of external terminals (number of pins) will therefore increase, and this will push up the cost. In some cases, it may even be impossible to integrate the ripple injection function into an integrated circuit (IC), due to limitation on the number of external terminals. Moreover, the feed-forward capacitor Cff of the switched-mode power supply disclosed in Japanese Examined Patent No. 4610588 is an element having a relatively large capacitance, so that the element need be attached externally, and the number of component increases as a consequence.

The present invention was conceived in consideration of the above-described subjects. It is therefore an object of the present invention to integrate the ripple injection function into an IC which serves as the control circuit in a switched-mode power supply based on the ripple control system, without increasing the number of external terminals.

According to the present invention aimed at achieving the above-described object, there is provided a switched-mode power supply. The power supply includes: a voltage input terminal through which DC voltage is input; a driver switching element connected to the input terminal; an inductor connected to the driver switching element; an output terminal connected to the inductor and outputting output voltage different from the DC voltage; and an integrated circuit outputting control pulses used for on-off control of the driver switching element. The integrated circuit includes: a ripple injection circuit adding a ripple component to a feedback voltage of the output voltage, wherein the ripple injection circuit has an integrator outputting an integral of the voltage at the node between the driver switching element and the inductor, and a series RC circuit connected to the output end of the integrator; a voltage comparator comparing a summed voltage of the ripple component and the feedback voltage with a predetermined voltage; and a control pulse generator generating the control pulse based on an output of the voltage comparator.

Preferably, the integrated circuit includes a voltage divider circuit dividing the voltage at the node between the driver switching element and the inductor, wherein the output voltage of the voltage divider circuit is fed to the generator.

Preferably, the integrated circuit includes a timer determining duty ratio of the control pulse depending on the input voltage and either the output voltage or a voltage proportional to the output voltage, wherein the control pulse generator generates the control pulse based on output of the timer and output of the voltage comparator.

Or preferably, the integrated circuit further includes an emulated voltage generating circuit generating an emulated voltage by smoothing the voltage output from the generator and a timer determining duty ratio of the control pulse depending on the input voltage and the emulated voltage, wherein the timer determines the pulse width depending on the input voltage and the emulated voltage.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a circuit diagram illustrating one embodiment of a DC-DC converter based on the switching regulator system of the present invention;

FIG. 2 is a circuit diagram illustrating an equivalent circuit of a ripple injection circuit in a switching control circuit of the DC-DC converter in one embodiment;

FIG. 3 is a timing chart illustrating changes in voltage at various points in the equivalent circuit shown in FIG. 2;

FIG. 4 is a circuit diagram illustrating a more specific applied example of the DC-DC converter in one embodiment shown in FIG. 1, having a ripple injection circuit;

FIG. 5 is a circuit diagram illustrating a modified example of the DC-DC converter shown in FIG. 1;

FIG. 6 is a circuit diagram illustrating a modified example of the DC-DC converter shown in FIG. 4;

FIG. 7 is a circuit diagram illustrating an exemplary configuration of a conventional switched-mode power supply having a ripple injection circuit; and

FIG. 8 is a circuit diagram illustrating an equivalent circuit of the ripple injection circuit configuring the switching control circuit shown in FIG. 7.

### DETAILED DESCRIPTION OF THE INVENTION

Preferred embodiments of the present invention will be explained below, referring to the attached drawings.

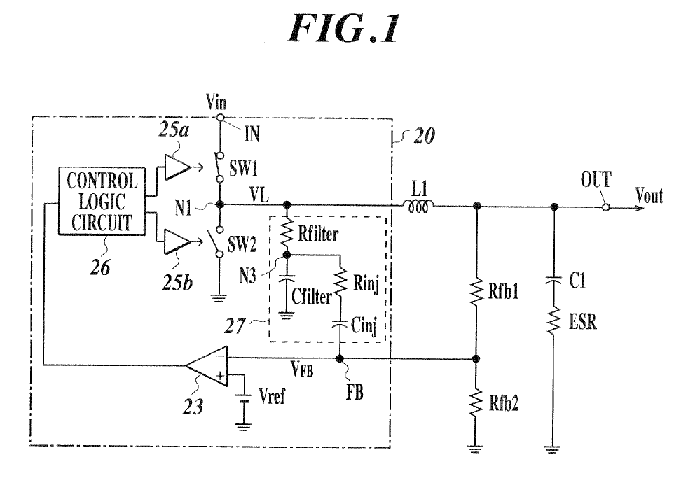

FIG. 1 illustrates embodiment of a DC-DC converter based on the switching regulator system according to the present invention.

The DC-DC converter of this embodiment includes an input terminal IN, a high-side driver switching element SW1, a low-side rectifier switching element SW2, a coil L1 as the inductor, a smoothing capacitor C1, an output terminal OUT, a switching control circuit 20, and series resistors R_{fb1} and R_{fb2}.

While not specifically limited, among the circuits and elements configuring the DC-DC converter, the switching control circuit 20 may be formed on a semiconductor chip to give a power supply control IC (integrated circuit), and the coil L1 and the capacitor C1 may be connected to an external terminal of the IC. The switching elements SW1, SW2 herein may be on-chip elements provided inside the switching control circuit 20, or may be externally-attached elements. This embodiment is effective typically for the case where a ceramic capacitor, having a small ESR, is used as the capacitor C1.

DC input voltage Vᵢₙ is applied through the terminal IN.

One terminal of the switching element SW1 is connected to the input terminal IN. The other terminal of the switching element SW1 is connected to one terminal of the coil L1. The other terminal of the coil L1 is connected to the outpt terminal OUT.

One terminal of the switching element SW2 is connected to a node between the switching element SW1 and the coil L1. The other terminal of the switching element SW2 is connected to a ground point.

Each of the driver switching element SW1 and rectifier switching element SW2 may typically be configured by a MOSFET (Metal-Oxide-Semiconductor field effect transistor).

One terminal of the smoothing capacitor C1 is connected to a node between the coil L1 and the output terminal OUT. The other terminal of the smoothing capacitor C1 is connected to a ground point.

In the steady state, when the driver switching element SW1 is turned on, the rectifier switching element SW2 is turned off, DC input voltage Vᵢₙ is applied to the coil L1, and the smoothing capacitor C1 is charged by current which flows towards the output terminal OUT.

On the other hand, when the driver switching element SW1 turns off, the rectifier switching element SW2 turns on, and current flows from the smoothing capacitor C1 through the coil L1 and the rectifier switching element SW2 to the ground point. DC output voltage Vₒᵤₜ is configured to have a predetermined voltage dropped from the DC input voltage Vᵢₙ by controlling the pulse width or frequency of the drive pulses depending on the ripples in the output voltage Vₒᵤₜ.

The switching control circuit 20 of this embodiment includes a control logic circuit 26, driver circuits 25a, 25b, a high-side driver switching element SW1, a low-side rectifier switching element SW2, a comarator 23, and a ripple injection circuit 27.

The control logic circuit 26 includes a control pulse generator and so forth. The control pulse generator generates the control pulses used for turning the switching elements SW1 and SW2 on or off alternately, upon reception of the output from the comparator 23, and output them to the driver circuits 25a, 25b. The control logic circuit 26 may be configured by a general adaptive ON timer used for a converter based on the ripple control system, or a predetermined ON time timer, minimum OFF time timer, flip-flop, or the like.

The driver circuits 25a, 25b generate, upon reception of the output from the control logic circuit 26, drive pulses used for turning the switching elements SW1, SW2 on or off. The drive pulse generated by the switching elements SW1 is fed to a control terminal (gate terminal) of the switching elements SW1. The drive pulse generated by the switching elements SW2 is fed to a control terminal (gate terminal) of the switching elements SW2.

One terminal of the resistor R_{fb1} is connected to a node between the coil L1 and the output terminal OUT. The other terminal of the resistor R_{fb1} is connected to one terminal of the resistor R_{fb2}. The other terminal of the resistor R_{fb2} is connected to a ground point.

The output voltage Vₒᵤₜ is divided by the series resistors R_{fb1} and R_{fb2}. The voltage of a node between the series resistors R_{fb1} and R_{fb2} is added to the output of the ripple injection circuit 27 and the summed voltage is fed as feedback voltage V_{FB} to an inverting input terminal of the comparator 23. The other input terminal of the comparator 23 receives a reference voltage Vref. An output terminal of the comparator 23 is connected to the control logic circuit 26.

In this embodiment, a ripple injection circuit 27 for injecting a ripple component is provided between a node N1 to which the coil L1 is connected, and a feedback node FB to which the feedback voltage V_{FB} is fed. The ripple injection circuit 27 is configured by an integrator and a series RC circuit. The integrator is a filter circuit typically composed of a resistor R_{filter} and a capacitor C_{filter}. The integrator herein outputs an integral of the voltage V_{L} at the node N1. The series RC circuit is configured by a resistor Rᵢₙⱼ and a capacitor Cᵢₙⱼ connected in series.

The ripple injection circuit 27 has a time constant adjusted so that the ripple component to be injected will have a triangular wave profile. More specifically, since the switching element SW1 turns on and off, the voltage V_{L} at the node N1 forms a square wave. When the ripple injection circuit 27 has a too small time constant, the ripple component may form a square wave. On the other hand, when the ripple injection circuit 27 has a too large time constant, an amplitude of the ripple component (triangular wave) may be small and insufficient for injecting the ripples. Therefore in this embodiment, the time constant of the circuit and constants of the elements are adjusted so that the ripple component to be injected will have a triangular wave with a desired amplitude, and so that the ripple injection circuit 27 may be configured by on-chip elements.

Now, a method of determining the time constant of the ripple injection circuit 27 and constants of the elements in this embodiment will be briefed.

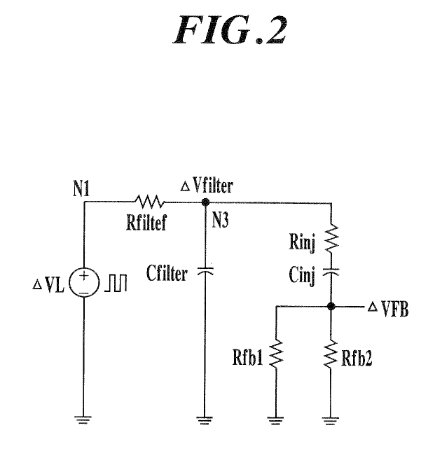

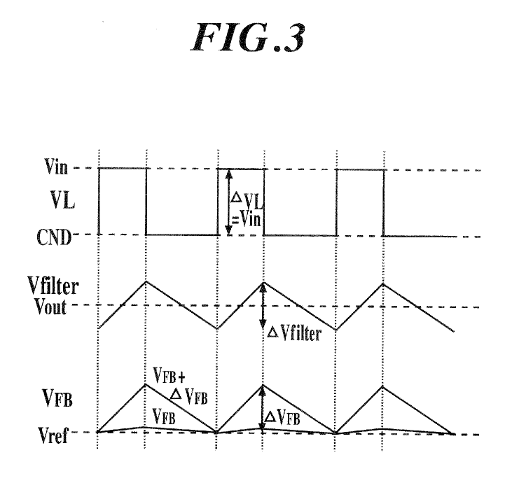

FIG. 2 illustrates an equivalent circuit of the ripple injection circuit 27 illustrated in FIG. 1. FIG. 3 illustrates changes, during operation of the DC-DC converter, in the voltage V_{L} at the node N1 to which the coil L1 is connected, voltage V_{filter} at a node N3 between the resistor R_{filter} and the capacitor C_{filter} in the integrator, and voltage of the feedback voltage V_{FB} having the ripple component injected therein.

In FIG. 2, denoting the amount of change in the voltage V_{L} at the node N1 as ΔV_{L}, amplitude of the voltage V_{filter} at the node N3 in the integrator as ΔV_{filter} impedance of the path between the node N3 to the ground GND in the integrator as Z_{filter}, impedance of the ripple injection circuit 27 as Zᵢₙⱼ, impedance of the voltage divider resistors R_{fb1}, R_{fb2} used for feedback as Z_{fb}, and the ripple component injected to the feedback node FB as ΔV_{FB}, ΔV_{filter} and ΔV_{FB} may be given by the equation (1) below:

$$Δ {V}_{filter} = \frac{{Z}_{filter}}{{R}_{filter} + {Z}_{filter}} \cdot Δ {V}_{L} \\ Δ {V}_{FB} = \frac{{Z}_{fb}}{{Z}_{inj} + {Z}_{fb}} \cdot Δ {V}_{filter} \qquad ( 1 )$$

It is understood from the equation (1), that the magnitude of the ripple component ΔV_{FB} may be determined by R_{filterr} Rᵢₙⱼ, and a combined resistance of parallel resistors R_{fb1}, R_{fb2}. In order to control ΔV_{FB} so as to give a triangular waveform, the time constant τ of the ripple injection circuit 27 is necessarily large. Assuming now that Cᵢₙⱼ is sufficiently larger than C_{filter} in the circuit illustrated in FIG. 2, the time constant τ of the ripple injection circuit 27 may be given by the equation (2) below:

τ=(R_{fb1}//R_{fb2}+Rᵢₙⱼ)·C_{filter} (2)

where, the symbol “//” represents a combined resistance of elements in parallel connection, so that R_{fb1}//R_{fb2} represents a combined resistance of R_{fb1} and R_{fb2}, that is, 1/{(1/R_{fb1})+1/R_{fb2})}.

It is understood from the equation (2) that, in the ripple injection circuit 27 of this embodiment, the time constant τ may have a large value by increasing the value of the resistor Rᵢₙⱼ, without increasing the value of capacitor C_{filter}. Note that, in order to control ΔV_{FB} so as to give a triangular waveform, it is necessary to adjust the time constant τ of the ripple injection circuit 27 longer than one cycle time of the switching. For an exemplary case where the operation at a switching frequency of several hundreds of kilohertz is aimed at, a desired level of time constant may be achieved by adjusting the resistance of the resistor Rᵢₙⱼ to several hundreds of kiloohm or around, only needing a capacitance of the capacitor C_{filter} of several picofarads or around. A capacitor of several picofarads or around may readily be integrated into an IC.

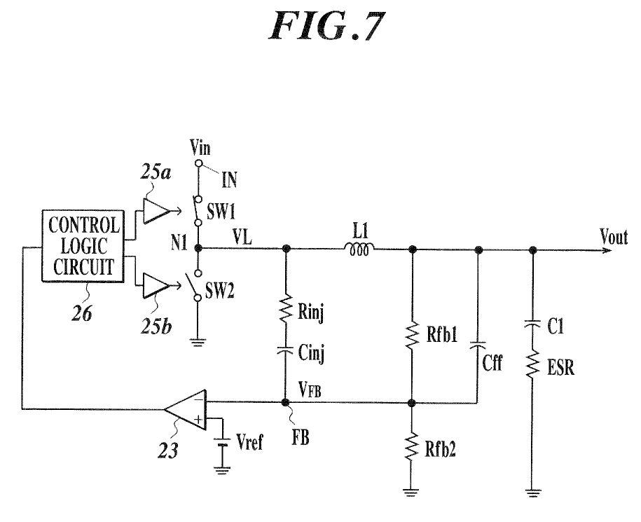

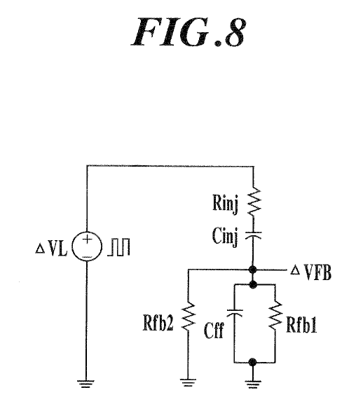

For comparative study, the present inventors examined the ripple injection circuit described in Japanese Examined Patent No. 4610588 (referred to as “prior invention”, hereinafter) mentioned in the above. FIG. 8 illustrates an equivalent circuit of the ripple injection circuit in the DC-DC converter of the prior invention illustrated in FIG. 7. In the ripple injection circuit of the prior invention, ΔV_{FB} which represents the ripple component injected to the feedback node FB may be given by the equation (3) below:

$$Δ {V}_{FB} = \frac{{Z}_{fb}}{{Z}_{inj} + {Z}_{fb}} \cdot Δ {V}_{L} \qquad ( 3 )$$

Assuming now that the value of Cᵢₙⱼ is sufficiently large, time constant τ′ of the ripple injection circuit of the prior invention may be given by the equation (4) below:

τ′=(R_{fb1}//R_{fb2}//Rᵢₙⱼ)·C_{ff} (4)

where, R_{fb1}//R_{fb2}//Rᵢₙⱼ represents a combined resistance of R_{fb1}, R_{fb2} and Rᵢₙⱼ, that is, 1/{(1/R_{fb1})+(1/R_{fb2})+(1/Rᵢₙⱼ)}.

According to an estimation by the present inventors using the equations (3), (4), the ripple injection circuit of the prior invention was found to need a capacitor having a capacitance of several hundreds of picofarad or larger, as the capacitor C_{ff} provided between the output terminal and the feedback node, if the circuit is intended to operate at a switching frequency of several hundreds of kilohertz while using a general resistor of 10 kΩ or around for the voltage divider resistor R_{fb2} for feedback use.

Accordingly, if the ripple injection circuit 27 according to the embodiment of the present invention is used while assuming that Cᵢₙⱼ in FIG. 2 and Cᵢₙⱼ in FIG. 8 have the same value, the capacitor C_{filter} adoptable herein may be good enough to have a capacitance only as small as approximately one-hundredth of that of the capacitor C_{ff}. Since the time constant optimum for generating the desired ripples is obtainable with such a small capacitance, the ripple injection circuit 27 is now readily built in an IC. This also successfully disuses the external terminal for connecting the capacitor, and reduces the number of external terminals of IC as a consequence. Note that the capacitance of Cᵢₙ may be several tens of picofarad, meaning that also the capacitor Cᵢₙⱼ may be built in the IC.

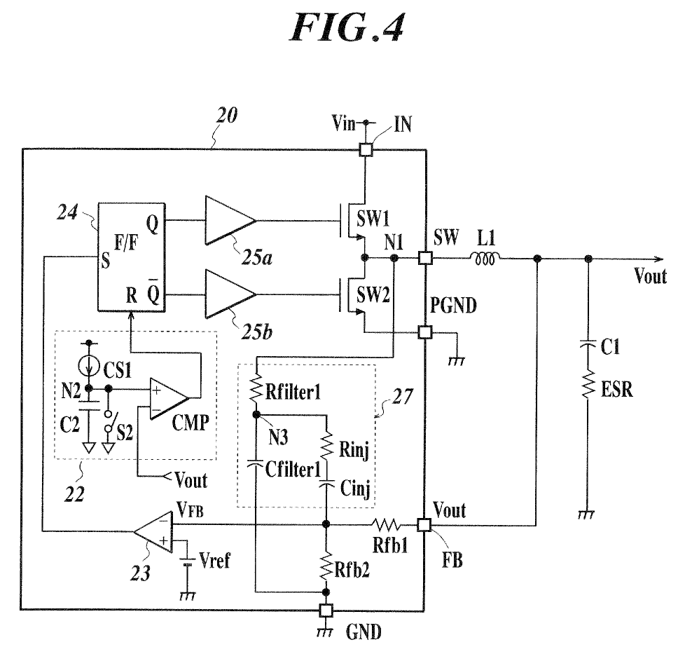

Next, a more specific applied example of the switching control circuit 20 using the ripple injection circuit 27 of this embodiment will be explained referring to FIG. 4.

The switching control circuit 20 illustrated in FIG. 4 includes a adaptive ON timer 22 and an RS flip-flop 24. The adaptive ON timer 22 feeds forward the input voltage and the output voltage, to thereby determine times when each switching elements SW1, SW2 turns on and off. Output of the timer 22 is fed to an R (reset) terminal of the RS flip-flop 24. Output of the comparator 23 is fed to an S (set) terminal of the RS flip-flop 24. Output terminals Q, /Q of the RS flip-flop 24 are connected to the driver circuits 25a, 25b, respectively. The RS flip-flop 24 generates drive pulses which turn the switching elements SW1, SW2 on or off, and outputs them from the output terminals Q, /Q to the driver circuits 25a, 25b. The control logic circuit 26 illustrated in FIG. 1 is configured by the adaptive ON timer 22 and the RS flip-flop 24.

The adaptive ON timer 22 of this embodiment is typically configured by a current source CS1, a capacitor C2, a switch S2 used for discharging, and a comparator CMP. The current source CS1 and the capacitor C2 are connected in series. The switch S2 for discharging is connected in parallel to the capacitor C2, and turned on or off typically by the output /Q of the flip-flop 24. A non-inverting input terminal of the comparator CMP is fed with voltage at the node N2 between the current source CS1 and the capacitor C2. An inverted input terminal of the comparator CMP is fed with the output voltage Vₒᵤₜ. Alternatively, the inverted input terminal may be fed with the feedback voltage V_{FB} proportional to the output voltage Vₒᵤₜ. The current source CS1 is configured to feed current I_{c} proportional to the input voltage Vᵢₙ (I_{c}∝Vᵢₙ).

Now, operations of the DC-DC converter, having the switching control circuit 20 configured as illustrated in FIG. 4, will be explained. For easier understanding, the description herein will separately be given for the case where a load connected to the output terminal varies while keeping the input voltage Vᵢₙ constant, and for the case where the input voltage Vᵢₙ varies while keeping the load constant. Note, however, that the both may concomitantly vary in practice, wherein the operations described in the next will proceed in parallel.

The first case to be discussed is that the load changes from heavy to light, while keeping the input voltage Vᵢₙ constant. In this case, since the input voltage Vᵢₙ is kept constant, so that current I_{c} of the current source CS1 in the adaptive ON timer 22 is kept constant. Accordingly, duration over which the voltage at the node N2 in the adaptive ON timer 22 reaches the output voltage Vₒᵤₜ will hardly vary. At the point of time when the voltage at the node N2 reaches the output voltage Vₒᵤₜ, the switching element SW1 is turned off. Since the load is light, the output voltage Vₒᵤₜ falls slowly. Accordingly, the point of time when the drive pulse of the switching element SW1 rises up to the high level and the switching element SW1 turns ON becomes later.

In other words, if the load becomes lighter, the period of the drive pulse of the switching element SW1 becomes longer. If the period of the drive pulse of the switching element SW1 becomes longer, the duty ratio becomes smaller, and thereby current which flows via the switching element SW1 through the coil L1 will decrease. When the load stabilizes thereafter, the duty ratio and the frequency of the drive pulse of the switching element SW1 are kept constant. Since the ripple control system does not rely upon an error amplifier, unlike the voltage control system and current control system, so that the above-described response takes place in a swift manner.

On the other hand, for the case where the load changes from light to heavy, while keeping the input voltage Vᵢₙ constant, the output voltage Vₒᵤₜ decreases in a relatively rapid manner, contrary to the above-described case. Accordingly, the point of time when the drive pulse of the switching element SW1 rises up to the high level and the switching element SW1 turns ON becomes earlier. In other words, if the load becomes heavier, the period of the drive pulse of the switching element SW1 becomes shorter. If the period of the drive pulse of the switching element SW1 becomes shorter, the duty ratio becomes larger, and thereby current which flows via the switching element SW1 through the coil L1 will increase. When the load stabilizes thereafter, the frequency will be kept constant.

Next, operations of the adaptive ON timer 22 for the cases where the input voltage Vᵢₙ is low and high, while keeping the load constant, will be explained.

When the input voltage Vᵢₙ is low, only a small amount of current flows from the input terminal IN to the coil L1 in the period over which the switching element SW1 turns ON, so that the output voltage elevates slowly. Low input voltage Vᵢₙ, however, means that also the amount of current I_{c} fed from the current source CS1 in the adaptive ON timer 22 is small. Therefore, a duration over which the voltage at the node N2 in the timer circuit reaches Vₒᵤₜ grows longer, and this delays the point of time when the output of the RS flip-flop 24 falls down to the low level. As a consequence, a duration over which the switching element SW1 is kept turned ON becomes longer.

On the other hand, when input voltage Vᵢₙ is high, a larger amount of current flows from the input terminal IN to the coil L1, so that the output voltage elevates rapidly. High input voltage Vᵢₙ, however, means that also the amount of current I_{c} fed from the current source CS1 in the adaptive ON timer 22 is large, so that a duration over which the voltage at the node N2 in the timer circuit reaches Vₒᵤₜ becomes shorter, and this advances the point of time when the output of the RS flip-flop 24 falls down to the low level. In other words, a duration over which the switching element SW1 is kept turned ON becomes shorter.

Accordingly, in the adaptive ON timer 22, product of current and time is regulated so as to keep almost constant value irrespective of magnitude of the input voltage Vᵢₙ. On the other hand, the point of time when the output of the comparator 23 changes, that is, the point of time when the switching element SW1 turns ON, will not vary if the load does not vary. Accordingly, if the input voltage Vᵢₙ varies, while keeping the load constant, the duty ratio of the drive pulse of the switching element SW1 will vary, and thereby the switching frequency is kept constant.

As described in the above, the adaptive ON timer 22 changes the pulse width of the control pulse when the input voltage and load vary and thereby the switching period may be kept constant. The adaptive ON time function may, therefore, be integrated into an IC.

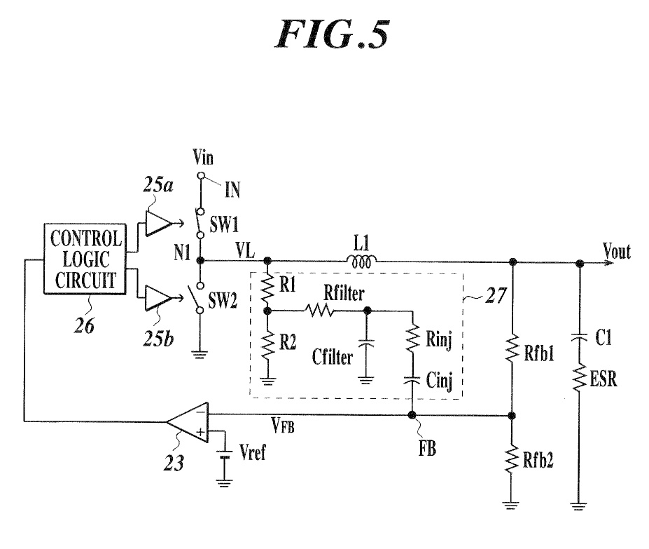

FIG. 5 illustrates a modified example of the switching control circuit 20 of the embodiment previously shown in FIG. 1. The modified example of the switching control circuit 20 includes a voltage divider circuit. The voltage divider circuit is configured by the resistors R₁, R₂ connected in series for voltage division. One terminal of the resistor R_{fb1} is connected to a node between the coil L1 and the node N1. The other terminal of the resistor R₁ is connected to one terminal of the resistor R₂. The other terminal of the resistor R₂ is connected to a ground point. The node between the series resistors R₁ and R₂ is connected to the integrator. The voltage V_{L} at the node N1 is divided by the series resistors R₁ and R₂. The divided voltage is input to the integrator. The voltage divider circuit combined with the integrator and the RC circuit may be understood as the ripple injection circuit 27.

Since the voltage divided by the voltage divider circuit is input to the integrator, the capacitors adoptable to the integrator and the series RC circuit may be those having large capacitance per unit area, while the dielectric strength thereof may otherwise be low. The area occupied by the circuit may be reduced, as a consequence.

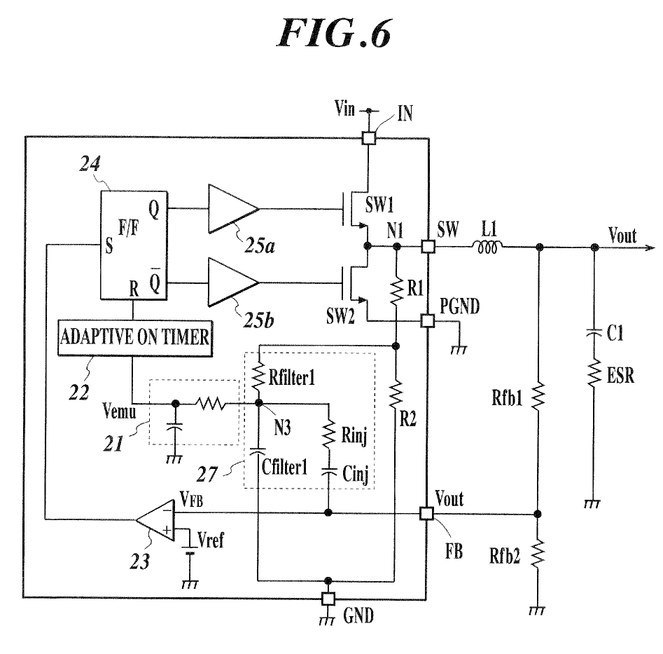

FIG. 6 illustrates a modified example of the switching control circuit 20 of the embodiment previously shown in FIG. 4. The switching control circuit 20 of this modified example includes a low-pass filter (emulated voltage generating circuit) 21 between the input terminal of the adaptive ON timer 22 and the node N3 of the ripple injection circuit. Output voltage of the low-pass filter 21 rather than the output voltage Vₒᵤₜ is input to the input terminal of the adaptive ON timer 22. The low-pass filter 21 produces voltage Vₑₘᵤ, which emulates the output voltage, by smoothing the voltage at the node N3. The voltage Vₑₘᵤ is fed to the adaptive ON timer 22. The series resistors R1 and R2 for dividing the voltage V_{L} at the node N1 is provided similarly to the modified example shown in FIG. 5, so as to feed voltage, after being divided from the voltage V_{L} by the resistors R₁ and R₂, to the ripple injection circuit 27. In this modified example, the series resistors R_{fb1} and R_{fb2} for dividing the output voltage are provided as externally-attached elements. Alternatively, of the resistors R_{fb1} and R_{fb2}, only the resistor R_{fb1} may be configured as an externally-attached element.

By virtue of this configuration, a terminal through which the output voltage is fed to the adaptive ON timer 22 is no longer necessary, and thereby the adaptive ON time function may be integrated into the IC, without increasing the number of external terminals.

In addition, the voltage divider circuit for dividing the voltage V_{L} at the node N1, to which the inductor L1 is connected, may be shared by the ripple injection circuit 27 and the adaptive ON timer 22.

By virtue of provision of the resistors R1 and R2 for voltage division, both of modified examples shown in FIG. 5 and FIG. 6 may be applied to the cases where the capacitor composing the ripple injection circuit 27 has a low dielectric strength. The capacitor intended for use by the present inventors has larger capacitance per unit area as the dielectric strength thereof decreases. In other words, the same capacitance is attainable by a smaller element. Accordingly, the circuits according to the modified examples illustrated in FIG. 5 and FIG. 6 may be implemented in smaller areas, as compared with the circuit illustrated in FIG. 1.

In the example illustrated in FIG. 4, the series resistors R_{fb1} and R_{fb2} for dividing the output voltage are integrated into the chip. This successfully reduces the number of components, but inconveniently fixes the output voltage V.

In contrast, the modified example illustrated in FIG. 6 allows arbitrary setting of the output voltage Vₒᵤₜ, by adjusting the values of the externally-attached resistors R_{fb1} and R_{fb2}.

The invention accomplished by the present inventors were specifically described in the above referring to the embodiments, without limiting the present invention. For example, while the emulated voltage generating circuit in the modified examples illustrated in FIG. 5 and FIG. 6 employed the low-pass filter 21 composed of one resistor and one capacitor, a low-pass filter circuit having a multi-stage configuration in which similar low-pass filters are connected in multiple stages is adoptable. Use of the circuit having multi-stage, low-pass filters might increase the number of elements, but successfully reduces the size of capacitor in each stage, as compared with the circuit having a single-stage, low-pass filter.

While the above-described embodiments dealt with the DC-DC converter having the switching elements SW1, SW2 connected as the elements built in the switching control IC, the switching elements SW1, SW2 may alternatively be configured as externally-attached elements. While the above-described embodiments dealt with the case where the switching element SW1 is configured as an N-channel MOS transistor, the switching element SW1 may alternatively be configured as a P-channel MOS transistor.

While the above-described embodiments used the switching element SW2 typically composed of a MOS transistor, as the low-side rectifying element connected between the starting end of the coil L1 and the earthing point, the present invention is applicable to the DC-DC converter after replacing the switching element SW2 with a diode.

What is claimed is:

1. A switched-mode power supply comprising:
a voltage input terminal through which DC voltage is input;
a driver switching element connected to the input terminal;
an inductor connected to the driver switching element;
an output terminal connected to the inductor and outputting output voltage different from the DC voltage; and
an integrated circuit outputting control pulses used for on-off control of the driver switching element, and including:
a ripple injection circuit adding a ripple component to a feedback voltage of the output voltage, wherein
the ripple injection circuit has an integrator outputting an integral of the voltage at the node between the driver switching element and the inductor, and a series RC circuit connected to the output end of the integrator;
a voltage comparator comparing a summed voltage of the ripple component and the feedback voltage with a predetermined voltage; and
a control pulse generator generating the control pulse based on an output of the voltage comparator.

2. The switched-mode power supply of claim 1, wherein the integrated circuit further includes a voltage divider circuit dividing the voltage at the node between the driver switching element and the inductor, wherein the output voltage of the voltage divider circuit is fed to the integrator.

3. The switched-mode power supply of claim 1, wherein the integrated circuit further includes a timer determining duty ratio of the control pulse depending on the input voltage and either the output voltage or a voltage proportional to the output voltage, wherein
the control pulse generator generates the control pulse based on output of the timer and output of the voltage comparator.

4. The switched-mode power supply of claim 1, wherein the integrated circuit further includes an emulated voltage generating circuit generating an emulated voltage by smoothing the voltage output from the generator and
a timer determining duty ratio of the control pulse depending on the input voltage and the emulated voltage, wherein
the timer determines the pulse width depending on the input voltage and the emulated voltage.
